(19) United States
(12) Patent Application Publication
(10) Pub. No.: US 2023/0058580 A1
(43) Pub. Date: Feb. 23, 2023

(54) Device for Controlling Shape of Discharged Liquid

(71) Applicant: Minxing Ke, Xiamen (CN)

(72) Inventor: Minxing Ke, Xiamen (CN)

(21) Appl. No.: 18/048,043

(22) Filed: Oct. 20, 2022

Related U.S. Application Data
(63) Continuation of application No. PCT/CN2021/070201, filed on Jan. 5, 2021.

(30) Foreign Application Priority Data
Jan. 22, 2020 (CN) 202010073133.7

(51) Int. Cl. B05B 1/02; B05B 1/18

(52) U.S. Cl. CPC B05B 1/02; B05B 1/185

(57) ABSTRACT

A device for controlling the shape of discharged liquid comprises a liquid inlet end and a liquid outlet end. A passage allowing liquid to flow therein is disposed between the liquid inlet end and the liquid outlet end. The liquid outlet end comprises a liquid outlet in a rotationally symmetric shape. The liquid inlet end comprises a liquid inlet formed in one end of the passage. A liquid outlet channel is disposed between the liquid outlet and the other end of the passage and communicated with the passage. Cross-sections of different positions of the liquid outlet channel in a liquid outlet direction are of a rotationally symmetric shape corresponding to the shape of the liquid outlet. Through the liquid outlet in a rotationally symmetric shape and the corresponding liquid outlet channel, a discharged liquid column has a special shape under the acting force of liquid molecules in air.

### CROSS REFERENCE TO RELATED APPLICATIONS

The present application is a Continuation Application of PCT Application No. PCT/CN2021/070201 filed on Jan. 5, 2021, which claims the benefit of Chinese Patent Application No. 202010073133.7 filed on Jan. 22, 2020. All the above are hereby incorporated by reference in their entirety.

### TECHNICAL FIELD

The invention relates to the technical field of liquid control, in particular to a device for controlling the shape of discharged liquid.

### DESCRIPTION OF RELATED ART

With the advancement of society and the improvement in living standards, people's requirements for products are not only functionality, more attention is paid to the aesthetics and usage experience of products. Most existing water outlet devices discharge water in a column shape, namely a non-aerated water column that flows continuously, and the cross-section of the water column is always circular in the flow direction and will not change.

### BRIEF SUMMARY OF THE INVENTION

The technical issue to be settled by the invention is to provide a device for controlling the shape of discharged liquid, which enables liquid to be discharged in a special column shape.

The technical solution adopted by the invention to settle the above technical issue is as follows: a device for controlling the shape of discharged liquid comprises a liquid inlet end and a liquid outlet end, wherein a passage allowing liquid to flow therein is formed between the liquid inlet end and the liquid outlet end, the liquid outlet end comprises a liquid outlet which is in a rotationally symmetric shape, the liquid inlet end comprises a liquid inlet which is formed in one end of the passage, a liquid outlet channel is disposed between the liquid outlet and the other end of the passage and is communicated with the passage, and cross-sections of different positions of the liquid outlet channel in a liquid outlet direction are in a rotationally symmetric shape corresponding to the shape of the liquid outlet.

The invention has the following beneficial effects: by means of the liquid outlet in a rotationally symmetric shape and the corresponding liquid outlet channel, a discharged liquid column has a special shape under the acting force of liquid molecules in air.

### BRIEF DESCRIPTION OF THE SEVERAL VIEWS OF THE DRAWINGS

FIG. 1 is a structural diagram of a device for controlling the shape of discharged liquid according to Embodiment 1 of the invention;

FIG. 2 is a bottom view of the device for controlling the shape of discharged liquid in FIG. 1;

FIG. 3 is a sectional view along A-A in FIG. 2;

FIG. 4 is a sectional view along B-B in FIG. 2;

FIG. 5 is a bottom view of the device for controlling the shape of discharged liquid according to Embodiment 2 of the invention;

FIG. 6 is a sectional view along A-A in FIG. 5;

FIG. 7 is a sectional view along B-B in FIG. 5;

FIG. 8 is a structural diagram of a device for controlling the shape of discharged liquid according to Embodiment 3 of the invention;

FIG. 9 is a bottom view of the device for controlling the shape of discharged liquid in FIG. 8;

FIG. 10 is a sectional view along A-A in FIG. 9;

FIG. 11 is a sectional view along B-B in FIG. 10;

FIG. 12 is a sectional view of a device for controlling the shape of discharged liquid according to Embodiment 4 of the invention;

FIG. 13 is a structural diagram of a device for controlling the shape of discharged liquid in a case where the cross-section of a passage is circular according to Embodiment 5 of the invention;

FIG. 14 is a structural diagram of a device for controlling the shape of discharged liquid in a case where the cross-section of a passage is circular according to Embodiment 6 of the invention′

FIG. 15 is a structural diagram of the device for controlling the shape of discharged liquid in a case where the cross-section of the passage is in a trefoil shape according to Embodiment 6 of the invention;

FIG. 16 is a structural diagram of the device for controlling the shape of discharged liquid in a case where the cross-section of the passage is in a trefoil shape according to Embodiment 6 of the invention;

FIG. 17 is a structural diagram of the device for controlling the shape of discharged liquid in a case where the cross-section of the passage is triangular according to Embodiment 6 of the invention;

FIG. 18 is a structural diagram of a device for controlling the shape of discharged liquid according to Embodiment 7 of the invention;

FIG. 19 is a sectional view along E-E in FIG. 18;

FIG. 20 is a top view of the device for controlling the shape of discharged liquid in FIG. 18;

FIG. 21 is a bottom view of the device for controlling the shape of discharged liquid in FIG. 18;

FIG. 22 illustrates sectional views along A-A, B-B, C-C, and D-D in FIG. 18;

FIG. 23 is a structural diagram of a device for controlling the shape of discharged liquid according to Embodiment 8 of the invention;

FIG. 24 is a front view of the device for controlling the shape of discharged liquid in FIG. 23;

FIG. 25 is a top view of the device for controlling the shape of discharged liquid in FIG. 24;

FIG. 26 is a bottom view of the device for controlling the shape of discharged liquid in FIG. 24;

FIG. 27 illustrates sectional views along A-A, B-B, C-C, and D-D in FIG. 24;

FIG. 28 is a sectional view of a device for controlling the shape of discharged liquid according to Embodiment 8 of the invention;

FIG. 29 is a bottom view of the device for controlling the shape of discharged liquid in FIG. 28;

FIG. 30 illustrates sectional views along A-A, B-B, C-C, and D-D in FIG. 28;

FIG. 31 is a structural diagram of the device for controlling the shape of discharged liquid according to Embodiment 10 of the invention;

FIG. 32 is a front view of the device for controlling the shape of discharged liquid in FIG. 31;

FIG. 33 illustrates sectional views along A-A, B-B, C-C, and D-D in FIG. 32;

FIG. 34 is a sectional view of a device for controlling the shape of discharged liquid according to Embodiment 11 of the invention;

FIG. 35 is a schematic diagram of a liquid column formed by a device for controlling the shape of discharged liquid according to Embodiment 12 of the invention;

FIG. 36 illustrates sectional views along A-A, B-B, C-C, D-D and E-E in FIG. 35;

FIG. 37 is a schematic diagram of a liquid column formed by a device for controlling the shape of discharged liquid according to Embodiment 13 of the invention;

FIG. 38 illustrates sectional views along A-A, B-B, C-C, D-D, and E-E in FIG. 37;

FIG. 39 is a schematic diagram of a liquid column formed by a device for controlling the shape of discharged liquid according to Embodiment 14 of the invention;

FIG. 40 illustrates sectional views along A-A, B-B, C-C, D-D, E-E, F-F, and G-G in FIG. 39;

FIG. 41 is a schematic diagram of a liquid column formed by a device for controlling the shape of discharged liquid according to Embodiment 15 of the invention;

FIG. 42 illustrates sectional views along A-A, B-B, C-C, D-D, E-E, F-F, and G-G in FIG. 41;

FIG. 43 is a schematic diagram of a liquid column formed by a device for controlling the shape of discharged liquid according to Embodiment 16 of the invention;

FIG. 44 illustrates sectional views along A-A, B-B, C-C, D-D, and E-E in FIG. 43;

FIG. 45 is a schematic diagram of a liquid column formed by a device for controlling the shape of discharged liquid according to Embodiment 17 of the invention;

FIG. 46 illustrates sectional views along A-A, B-B, C-C, D-D, and E-E in FIG. 45;

Reference signs:
1, liquid inlet; 2, passage; 3, liquid outlet; 4, liquid outlet channel; 5, guide section; 6, slow-down section; 7, guide plate; 8, filter device; 9, temperature control device; 10, liquid storage tank; 11, automatic liquid inlet device; 12, liquid column.

### DETAILED DESCRIPTION OF THE INVENTION

The technical contents, purposes and effects of the invention will be described in detail below in conjunction with embodiments and accompanying drawings.

The key conception of the invention lies in that a liquid outlet in a rotationally symmetric shape and a corresponding liquid outlet channel are used to enable a discharged liquid column to be in a special shape.

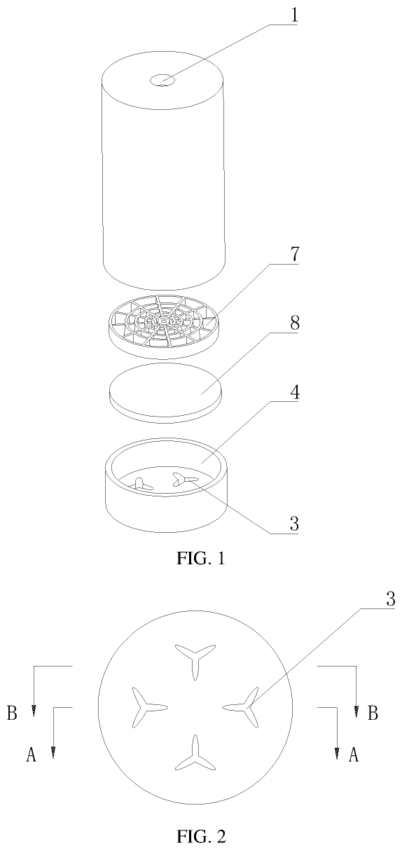

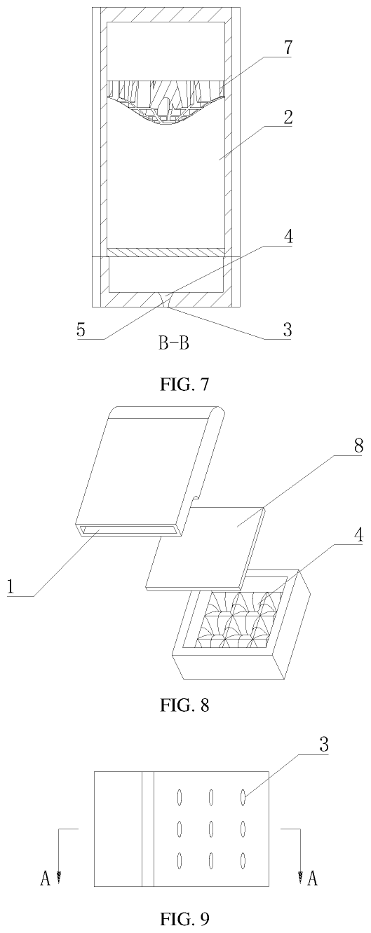

Referring to FIG. 1-FIG. 21, a device for controlling the shape of discharged liquid comprises a liquid inlet end and a liquid outlet end, wherein a passage allowing liquid to flow therein is disposed between the liquid inlet end and the liquid outlet end, the liquid outlet end comprises a liquid outlet which is in a rotationally symmetric structure, the liquid inlet end comprises a liquid inlet which is formed in one end of the passage, a liquid outlet channel is disposed between the liquid outlet and the other end of the passage and is communicated with the passage, and cross-sections of different positions of the liquid outlet channel in a liquid outlet direction are in a rotationally symmetric shape corresponding to the shape of the liquid outlet.

The working principle of the invention is as follows: liquid flows out along the liquid outlet channel via the liquid outlet in the rotationally symmetric shape to form a liquid column in a special shape; when the liquid continuously flows into air to form the liquid column, the cross-section of the liquid column gradually tends to be circular under the acting force of liquid molecules.

During the falling process, the cross-section of the liquid column will become circular gradually; after becoming circular, the cross-section of the liquid column will continue to change under the action of the internal pressure and inertia force of the liquid to be in a shape which is centrally symmetric with the shape of the liquid outlet; The liquid continues to fall, and the cross-section of the liquid column tends to be circular again; the liquid continues to fall, the cross-section of the liquid columns changes to be in the same shape as the liquid outlet; and during the subsequent liquid falling process of the liquid, the cross-section of the liquid column changes repeatedly and cyclically in the falling direction to form a non-rotational liquid column.

From the above description, the invention has the following beneficial effects: by means of the liquid outlet in a rotationally symmetric shape and the corresponding liquid outlet channel, a discharged liquid column has a special shape under the acting force of liquid molecules in air.

Further, the liquid outlet is in an axially symmetric shape.

From the above description, the liquid outlet in an axially symmetric shape can keep the cross-section of the liquid column in balance when the cross-section of the liquid column changes, thus prolonging the duration of the liquid column in a special shape.

Further, the liquid outlet channel is rotationally twisted with the center axis of the liquid outlet channel as a rotation center, and the cross-sections of different positions of the rotationally twisted liquid outlet channel in the liquid outlet direction are in a rotationally symmetric shape corresponding to the shape of the liquid outlet.

From the above description, by means of the liquid outlet in a rationally symmetric shape and the corresponding rotationally twisted liquid outlet channel, when liquid flows out along the rotationally twisted liquid outlet channel to form a liquid column, a centrifugal force for the liquid to rotate around the center axis of the liquid column will be generated; according to different degrees of rotational twisting of the liquid outlet channel, the centrifugal force can counteract part of or all the acting force of liquid molecules, so the liquid column can resist deformation and have a special shape.

Further, the area of the liquid outlet is smaller than the areas of the cross-sections of the liquid outlet channel, a guide section is disposed on an inner wall of the liquid outlet channel and is communicated with the liquid outlet, and the area of a cross-section of the guide section is constant or decreases gradually in the liquid outlet direction.

From the above description, the guide section is disposed on the inner wall of the liquid outlet channel and is used for limiting the flow direction of liquid to enable the liquid to flow smoothly, such that the liquid can flow from a portion with a large cross-sectional area to a portion with a small cross-sectional area; and under the action of pressure, the liquid tends to flow smoothly, and a discharged liquid column can be maintained in a special shape for a long time.

Further, a slow-down section is disposed in at least one of the passage and the liquid outlet channel, the area of a cross-section of the slow-down section decreases gradually in the liquid outlet direction, and a change rate of the area of the cross-section of the slow-down section decreases gradually in the liquid outlet direction.

From the above description, the slow-down section is disposed in the passage or the liquid outlet channel to guide liquid to some extent and limit the flow direction of liquid to enable the liquid to flow smoothly, and the change rate of the area of the cross-section of the slow-down section decreases gradually in the liquid outlet direction, such that the slow-down effect can be further improved.

Further, at least one slow-down section is disposed in the liquid outlet channel.

From the above description, multiple slow-down sections may be disposed in the liquid outlet channel to fulfill a multi-stage slow-down effect to ensure that liquid flows in the passage smoothly.

Further, at least one slow-down section is disposed in the passage.

From the above description, multiple slow-down sections may be disposed in the passage to a multi-stage slow-down effect to ensure that liquid flows in the passage smoothly.

Further, cross-sections of different positions of the passage in the liquid outlet direction are in a same shape and are of a rotationally symmetric structure, and areas of the cross-sections in the passage are equal.

From the above description, the cross-sections which are in the same shape and have equal areas are disposed in the passage to limit liquid that flows disorderly, and after the disordered liquid flows through the passage by a certain length, the flow direction of the liquid tends to be stable; and the cross-sections of the passage are of a rotationally symmetric structure, such that the liquid can flow into the liquid outlet channel smoothly.

Further, guide ribs are disposed in the passage and are perpendicular to the liquid outlet direction.

From the above description, the guide ribs perpendicular to the liquid outlet direction are disposed in the passage, can retard the flowing of liquid to some extent, and can limit the flow direction of the liquid to keep the flow direction of the liquid in order; and the guide ribs can limit the pressure and flow speed of liquid flowing in from the liquid inlet end.

Further, a filter device used for decreasing the pressure of liquid and slowing down the liquid is disposed at an end, close to the liquid outlet channel, in the passage.

From the above description, considering that a turbulent flow or a local high-speed flow will be formed by liquid entering air from the device for controlling the shape of discharged liquid under the action of pressure variation, the filter device is disposed in the passage, and a pressure difference can be formed between an inflow side and an outflow side of the filter device, such that after the liquid flows through the filter device, the liquid can flow smoothly without changing the flow speed, and the pressure of the liquid can be decreased.

Further, at least one liquid outlet is formed, at least one liquid outlet channel is disposed, and the at least one liquid outlet channel is in one-to-one correspondence with the at least one liquid outlet.

Further, a temperature control device is disposed at an end, close to the liquid inlet end, in the passage.

From the above description, by means of the temperature control device, liquid can be maintained at a suitable temperature to meet user's requirements.

Referring to FIG. 1-FIG. 4, Embodiment 1 of the invention is as follows: As shown in FIG. 1, this embodiment provides a device for controlling the shape of discharged liquid, comprising a liquid inlet end, a liquid outlet end, a guide plate 7, and a filter device 8, wherein a passage 2 allowing liquid to flow therein is disposed between the liquid inlet end and the liquid outlet end, the liquid outlet end comprises liquid outlets 3 which are in a trefoil shape with three symmetry axes, the liquid inlet end comprises a liquid inlet 1 formed in one end of the passage 2, and liquid outlet channels 4 corresponding to the liquid outlets 3 are disposed between the liquid outlets 3 and the other end of the passage 2 and are communicated with the passage 2;

Cross-sections of the liquid outlet channels 4 are in the same shape as the liquid outlets 3;

Cross-sections of different positions of the passage 2 in a liquid outlet direction are circular, and the areas of the cross-sections in the passage 2 are equal;

The guide plate 7 is composed of crossed guide ribs, is perpendicular to a liquid inlet direction, and is disposed at an end, close to the liquid inlet 1, in the passage 2;

The guide plate 7 can limit the flow direction of liquid, can retard the flowing of liquid to enable the liquid to flow in the passage approximately in the same direction and at the same speed, and can remove vortexes between the guide plate 7 and the filter device 8; ‘0 The filter device 8 is perpendicular to the liquid outlet direction and is disposed at an end, close to the liquid outlet channel 4, in the passage 2, wherein the filter device 8 may be a multi-layer filter screen, a high-density filter screen, or a filter cartridge;

The filter device 8 can apply a great resistance to liquid, and a large pressure difference can be formed between the inflow side and the outflow side of the filter device 8 to decrease the pressure of liquid, such that the liquid can flow smoothly; and after the liquid flows through the filter device 8, the flow direction of the liquid is perpendicular to the surface of the filter device 9;

The area of the liquid inlet 1 is smaller than the areas of the cross-sections of the passage 2;

As shown in FIG. 2, four liquid outlets 3 are regularly distributed in the liquid outlet end, and four liquid outlet channels 4 respectively corresponding to the four liquid outlets 3 are disposed between the four liquid outlets 3 and the other end of the passage 2;

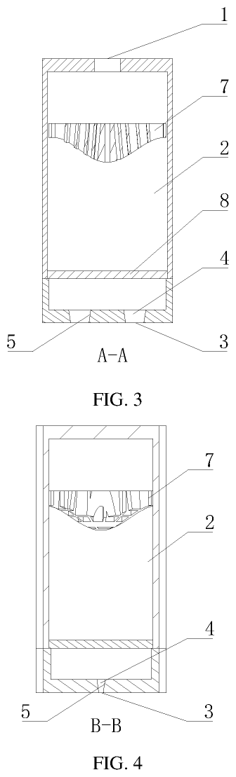

As shown in FIG. 3 and FIG. 4, guide sections 5 are disposed on inner walls of the four liquid outlet channels 4 respectively and are communicated with the corresponding liquid outlets 3, and the areas of cross-sections of the four guide sections 5 decrease uniformly in the liquid outlet direction and are smaller than the areas of the cross-sections of the passage 2.

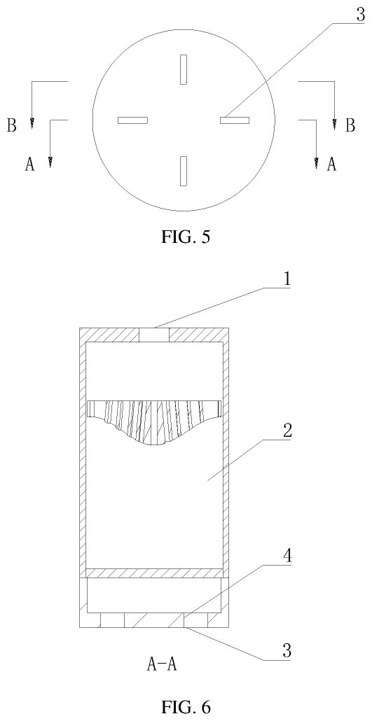

Referring to FIG. 5-FIG. 7, Embodiment 2 of the invention is as follows: Referring to Embodiment 1, Embodiment 2 is different from Embodiment 1 in the following aspect:

As shown in FIG. 5, the liquid outlets 3 are rectangular.

Referring to FIG. 8-FIG. 11, Embodiment 3 of the invention is as follows: Referring to Embodiment 1, Embodiment 3 is different from Embodiment 1 in the following aspects: As shown in FIG. 8, the cross-sections of different positions of the passage 2 in the liquid outlet direction are square, and the areas of the cross-sections in the passage 2 are equal;

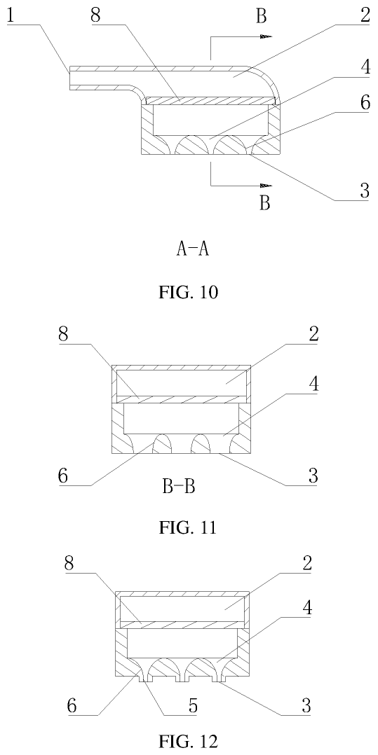

Referring to FIG. 9 and FIG. 10, the liquid outlets 3 are in an oval shape with two symmetry axes, the number of the liquid outlets 3 is nine, and nine liquid outlet channels 4 respectively corresponding to the nine liquid outlets 3 are disposed between the nine liquid outlets 3 and the other end of the passage 2;

As shown in FIG. 10 and FIG. 11, slow-down sections 6 are disposed on inner walls of the nine liquid outlet channels 4 respectively, the slow-down sections are curved portions that protrude inwards, and the areas of cross-sections of the slow-down sections 6 decrease gradually in the liquid outlet direction, and the change rate of the areas of the cross-sections of the slow-down sections 6 decreases gradually in the liquid outlet direction.

Referring to FIG. 12, Embodiment 4 of the invention is as follows:

Referring to Embodiment 3, Embodiment 4 is different from Embodiment 3 in the following aspects:

Referring to FIG. 12, guide sections 5 and slow-down sections 6 are disposed on inner walls of the nine liquid outlet channels 4 respectively, two ends of each guide section 5 are connected to one liquid outlet 3 and one end of the corresponding slow-down section 6 respectively, and the other end of each slow-down section 6 is communicated with the passage 2;

The areas of cross-sections of different positions of the guide sections 5 are equal.

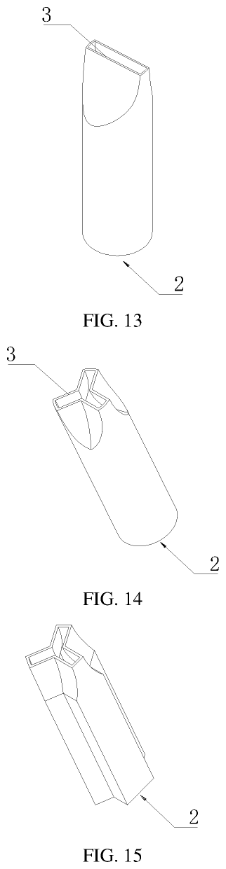

Referring to FIG. 13, Embodiment 5 of the invention is as follows:

Referring to Embodiment 1, Embodiment 5 is different from Embodiment 1 in the following aspect:

As shown in FIG. 13, the liquid outlets 3 are in a rectangular shape with two symmetry axes, the cross-sections of different positions of the passage 2 in the liquid outlet direction are circular, and the areas of the cross-sections in the passage 2 are equal.

Referring to FIG. 14-FIG. 17, Embodiment 6 of the invention is as follows:

Referring to Embodiment 1, Embodiment 6 is different from Embodiment 1 in the following aspects:

As shown in FIG. 14, the liquid outlets 3 are in a trefoil shape with rectangular leaves, the cross-sections of different positions of the passage 2 in the liquid outlet direction are circular, and the areas of the cross-sections in the passage 2 are equal;

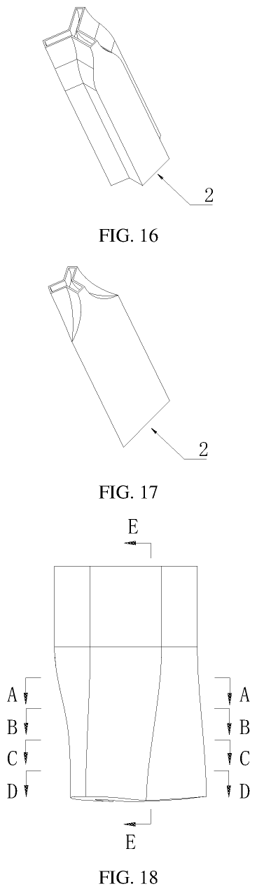

As shown in FIG. 15 and FIG. 16, the cross-sections of different positions of the passage 2 in the liquid outlet direction may be in a trefoil shape with three rectangular leaves, which is similar to the shape of the liquid outlets 3; and the areas of the cross-sections in the passage 2 are equal;

As shown in FIG. 17, the cross-sections of different positions of the passage 2 in the liquid outlet direction are triangular, and the areas of the cross-sections in the passage 2 are equal;

When liquid flows through an irregular pipe, valve, pressure reduction device or limiting device, the flow speed of the liquid will becomes high locally, and a large quantity of vortexes will be generated, leading to poor flowing stability of the liquid; after the disordered liquid flows through the passage with the cross-sections at different positions in the liquid outlet direction being in the same shape and having the same area, the flow direction of the liquid tends to be stable gradually; and the cross-sections of the passage are preferably in a symmetric shape which is the same as the shape of the liquid outlets, so that the stability of a liquid column formed by discharged liquid can be improved;

Referring to FIG. 18-FIG. 22, Embodiment 7 of the invention is as follows:

Referring to Embodiment 1, Embodiment 7 is different from Embodiment 1 in the following aspects:

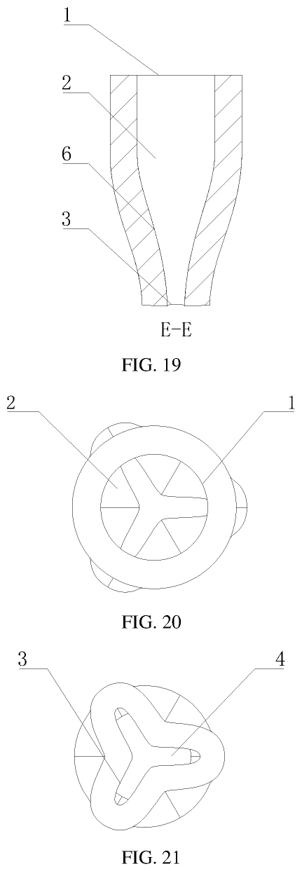

As shown in FIG. 19, the areas of the cross-sections of the liquid outlet channels 4 decrease gradually in the liquid outlet direction, slow-down sections 6 are disposed on inner walls of the liquid outlet channels 4 and are curved portions which protrude inwards, the areas of cross-sections of the slow-down sections 6 decrease gradually in the liquid outlet direction, and the change rate of the areas of the cross-sections of the slow-down sections 6 decreases gradually in the liquid outlet direction;

As shown in FIG. 22, the cross-sections of different positions of the liquid outlet channels 4 in the liquid outlet direction are in a rotationally symmetric shape which is the same as the shape of the liquid outlets 3.

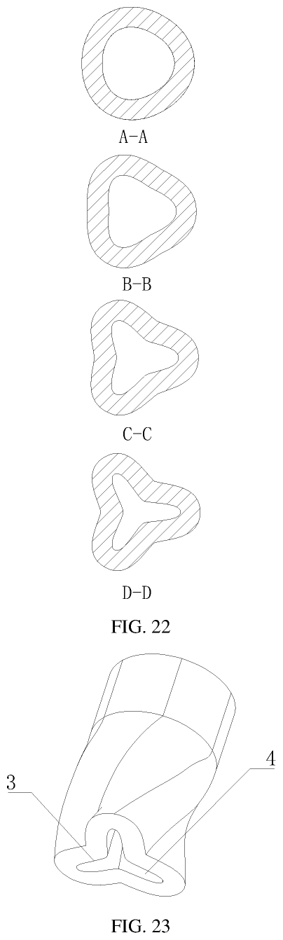

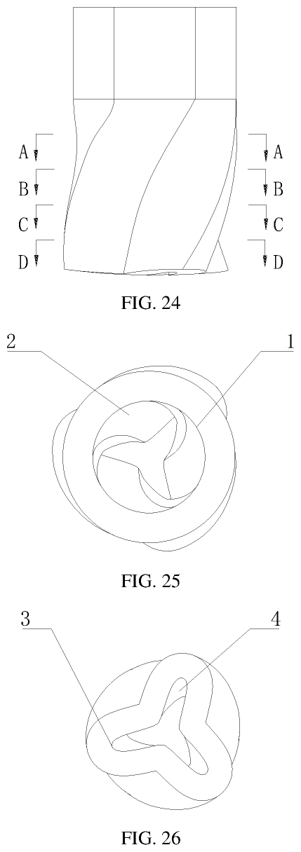

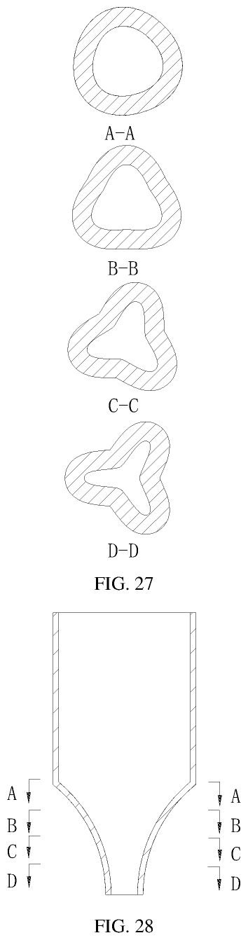

Referring to FIG. 23-FIG. 27, Embodiment 8 of the invention is as follows:

Referring to Embodiment 7, Embodiment 8 is different from Embodiment 7 in the following aspect:

The liquid outlet channels 4 are rotationally twisted with the center axis of the liquid outlet channels 4 as a rotation center.

Referring to FIG. 28-FIG. 30, Embodiment 9 of the invention is as follows:

Referring to Embodiment 1, Embodiment 9 is different from Embodiment 1 in the following aspects:

As shown in FIG. 28, the cross-sections of different positions of the passage 2 in the liquid outlet direction are square, and the areas of the cross-sections in the passage 2 are equal;

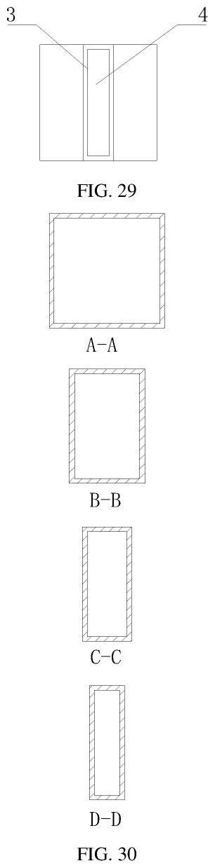

As shown in FIG. 29 and FIG. 30, the liquid outlets 3 are rectangular, and the areas of cross-sections of the liquid outlet channels 4 decrease gradually in the liquid outlet direction.

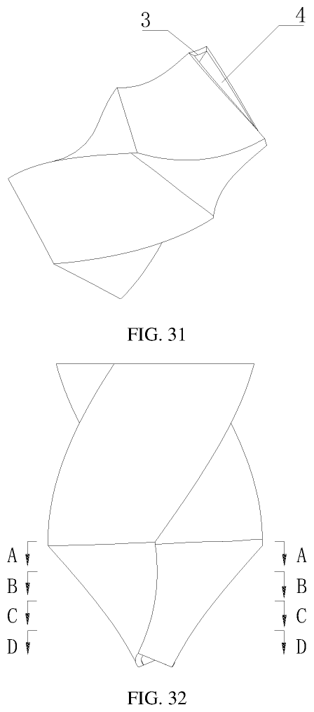

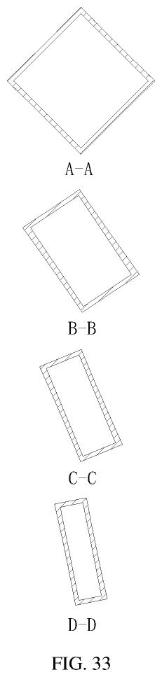

Referring to FIG. 31-FIG. 33, Embodiment 10 of the invention is as follows:

Referring to Embodiment 9, Embodiment 10 is different from Embodiment 9 in the following aspect:

The liquid outlet channels 4 are rotationally twisted with the center axis of the liquid outlet channels 4 as a rotation center, and the cross-sections of the rotationally twisted liquid outlet channels 4 are in a rotationally symmetric shape corresponding to the shape of the liquid outlets 3.

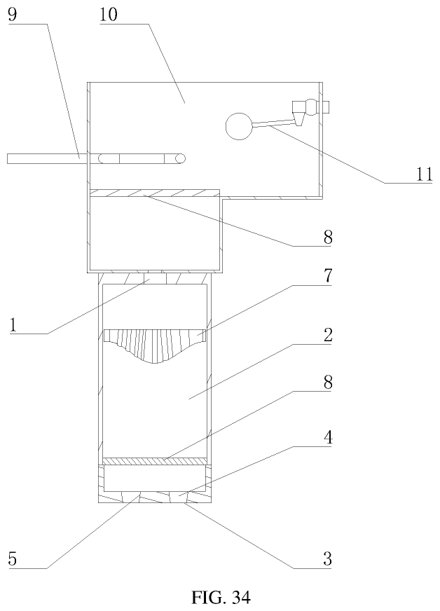

Referring to FIG. 34, Embodiment 11 of the invention is as follows:

Referring to Embodiment 1, Embodiment 11 is different from Embodiment 1 in the following aspect:

The discharged liquid control device further comprises a liquid storage box 10, wherein a liquid outlet of the liquid storage box 10 is communicated with the liquid inlet 1, a temperature control device 9 and an automatic liquid inlet device 11 are disposed in the liquid storage box 10, and the temperature control device 9 and the automatic liquid inlet device 11 are disposed on side walls of the liquid storage box respectively;

Wherein, the temperature control device 9 is used for adjusting the temperature of liquid stored in the liquid storage box, and the automatic liquid inlet device 11 is used for controlling the liquid level in the liquid storage box to obtain a stable and suitable pressure. The realization of the temperature control function and automatic liquid inlet function belongs to the prior art, and will not be detailed here.

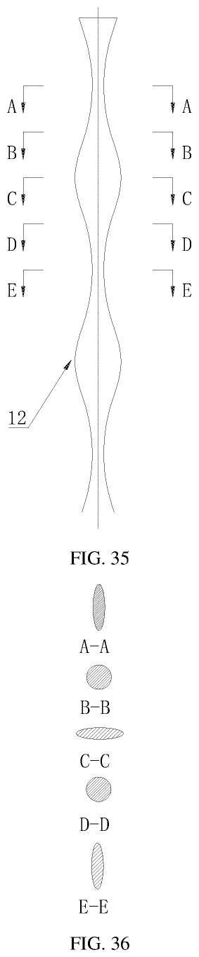

Referring to FIG. 35-FIG. 36, Embodiment 12 of the invention is as follows:

Referring to Embodiment 1, Embodiment 12 is different from Embodiment 1 in the following aspect:

The liquid outlets 3 are in an oval shape with two symmetry axes; As shown in FIG. 36, the sectional views along A-A, B-B, C-C, D-D and E-E respectively illustrate the shapes of the cross-sections of different positions of a liquid column 12 in the falling direction;

During the falling process of liquid, under the influence of the acting force of liquid molecules, the cross-section of the liquid column 12 at position A-A is in an oval shape, which is the same as the shape of the liquid outlets 3, changes to be circular at position B-B, changes to be in an oval shape, which is rotated by 90° with respect to the shape of the cross-section at position A-A, at position C-C, changes to be circular again at position D-D, and changes to be in an oval shape the same as the shape of the liquid outlets 3 at position E-E; during the subsequent falling process of the liquid, the cross-section of the liquid column 12 changes repeatedly and cyclically in the falling direction of the liquid to form a non-rotational liquid column;

Wherein, the liquid outlets of the liquid column control device, which forms the non-rotational liquid column, are preferably in an axially symmetric shape with symmetry axes, such as a diagonal shape or an oval shape with two symmetry axes, a trefoil shape with three symmetry axes, a quatrefoil shape with four symmetry axes, a quintefoil shape with five symmetry axes, or an axially symmetric shape with more symmetry axes, and the liquid outlets are also in an axially symmetric shape, such that the cross-section of the liquid column can be kept in balance when changing, thus prolonging the duration of the liquid column in a special shape.

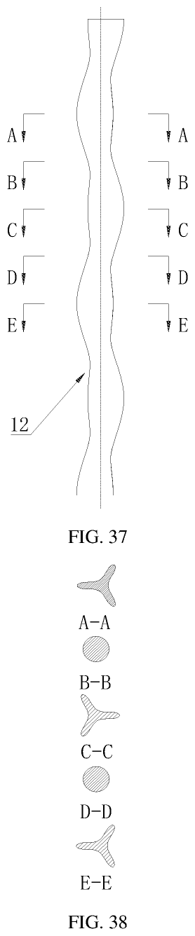

Referring to FIG. 37-FIG. 38, Embodiment 13 of the invention is as follows:

Referring to Embodiment 12, Embodiment 13 is different from Embodiment 12 in the following aspect:

As shown in FIG. 38, the cross-section at position A-A is in a trefoil shape, the cross-section at position C-C is in a trefoil shape which is centrally symmetric with the shape of the cross-section at position A-A, and the cross-section at position E-E is in a trefoil shape which is the same as the shape of the cross-section at position A-A.

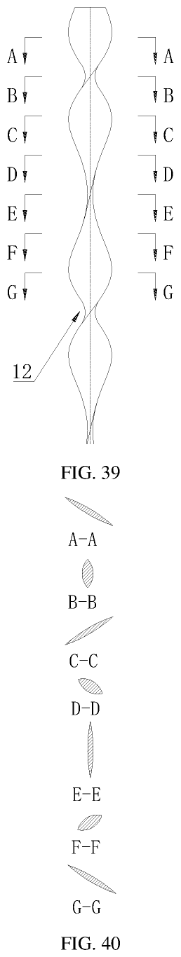

Referring to FIG. 39-FIG. 40, Embodiment 14 of the invention is as follows:

Referring to Embodiment 7, Embodiment 14 is different from Embodiment 7 in the following aspect:

The liquid outlets 3 are in a diagonal shape which is formed by connecting two arcs end-to-end and has two symmetry axes;

As shown in FIG. 40, the sectional views along A-A, B-B, C-C, D-D, E-E, F, and G-G respectively illustrate the shape of the cross-section of the liquid column 12 at different positions in the falling direction;

The rotationally twisted liquid outlet channels 4 provides a centrifugal force for falling liquid to rotate around the center axis of the liquid column 12, and the centrifugal force counteracts part of the acting force of liquid molecules;

As shown in FIG. 40, during the falling process of liquid, the cross-section of the liquid column 12 at position A-A is in a diagonal shape which is the same as the shape of the liquid outlets 3, changes to be in a diagonal shape which is approximate to a circle at position B-B, changes to be in a diagonal shape, which is the same as the shape of the cross-section at position A-A, at position C-C, changes to be in a diagonal shape which is approximate to a circle again at position D-D, changes to be in a diagonal shape, which is the same as the shape of the cross-section at position A-A, at position E-E, changes to be in a diagonal shape which is approximate to a circle again at position F-F, and changes to be in a diagonal shape, which is the same as the shape of the cross-section at position A-A, at position G-G;

During the subsequent falling process of the liquid, the cross-section of the liquid column 12 changes repeatedly and cyclically in the falling direction to form a semi-rotational liquid column finally.

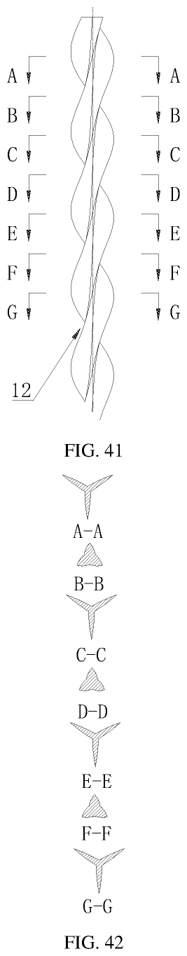

Referring to FIG. 41-FIG. 42, Embodiment 15 of the invention is as follows:

Referring to FIG. 14, Embodiment 15 is different from Embodiment 14 in the following aspect:

The liquid outlets 3 are in a trefoil shape with three symmetry axes;

The rotationally twisted liquid outlet channels 4 provides a centrifugal force for falling liquid to rotate around the center axis of the liquid column 12, and the centrifugal force counteracts part of the acting force of liquid molecules;

As shown in FIG. 42, during the falling process of liquid, the cross-section of the liquid column 12 at position A-A is in a trefoil shape which is the same as the shape of the liquid outlets 3, changes to be in a trefoil shape which is approximate to a circle at position B-B, changes to be in a trefoil shape, which is the same as the shape of the cross-section at position A-A, at position C-C, changes to be in a trefoil shape which is approximate to a circle again at position D-D, changes to be in a trefoil shape, which is the same as the shape of the cross-section at position A-A, at position E-E, changes to be in a trefoil shape which is approximate to a circle again at position F-F, and changes to be in a trefoil shape, which is the same as the shape of the cross-section at position A-A, at position G-G;

During the subsequent falling process of the liquid, the cross-section of the liquid column 12 changes repeatedly and cyclically in the falling direction to form a semi-rotational liquid column finally.

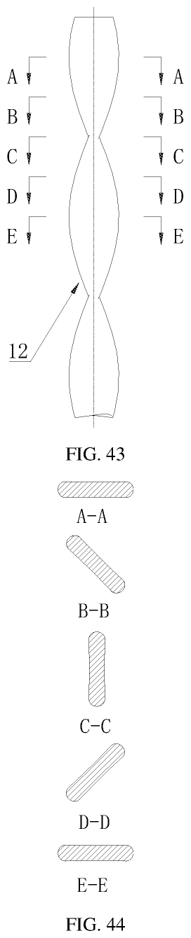

Referring to FIG. 43-FIG. 44, Embodiment 16 of the invention is as follows:

As shown in FIG. 43, the liquid column 12 formed by liquid flowing out of the device for controlling the shape of discharged liquid is a spiral column;

The rotationally twisted liquid outlet channels 4 provides a centrifugal force for falling liquid to rotate around the center axis of the liquid column 12, and the centrifugal force counteracts all the acting force of liquid molecules;

As shown in FIG. 44, the sectional views along A-A, B-B, C-C, D-D, and E-E respectively illustrates the shape of the cross-section of the liquid column 12 at different positions in the liquid outlet direction, and the shape of the cross-section of the liquid column 12 at different positions in the liquid outlet direction is the same.

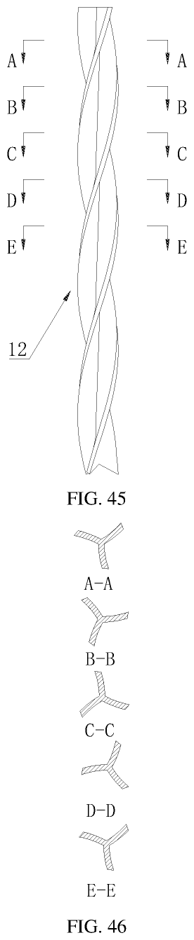

Referring to FIG. 45-FIG. 46, Embodiment 17 of the invention is as follows:

As shown in FIG. 45, a liquid column 12 flowing out of the device for controlling the shape of discharged liquid is a spiral column;

rotationally twisted liquid outlet channels 4 provides a centrifugal force for falling liquid to rotate around the center axis of the liquid column 12, and the centrifugal force counteracts all the acting force of liquid molecules;

As shown in FIG. 46, the sectional views along A-A, B-B, C-C, D-D, and E-E respectively illustrates the shape of the cross-section of the liquid column 12 at different positions in the liquid outlet direction, and the shape of the cross-section of the liquid column 12 at different positions in the liquid outlet direction is the same.

According to the device for controlling the shape of discharged liquid, by means of the liquid outlet in a rotationally symmetric shape and the corresponding liquid outlet channel, a discharged liquid column deforms under the acting force of liquid molecules in air to be in a special shape; and the liquid outlet channel is rotationally twisted to different degrees, such that the discharged liquid column can resist part of or all deformation to be in a special shape.

The above embodiments are merely illustrative ones of the invention, and are not used to limit the patent scope of the invention. All equivalent transformations made based on the specification and accompanying drawings of the invention, or direct or indirect applications to relating technical fields should also fall within the protection scope of the patent of invention.

What is claimed is:

1. A device for controlling the shape of discharged liquid, comprising a liquid inlet end and a liquid outlet end, a passage allowing liquid to flow therein being disposed between the liquid inlet end and the liquid outlet end, wherein the liquid outlet end comprises a liquid outlet which is in a rotationally symmetric shape, the liquid inlet end comprises a liquid inlet formed in an end of the passage, a liquid outlet channel is disposed between the liquid outlet and another end of the passage and is communicated with the passage, and cross-sections of different positions of the liquid outlet channel in a liquid outlet direction are in a rotationally symmetric shape corresponding to the shape of the liquid outlet.

2. The device for controlling the shape of discharged liquid according to claim 1, wherein the liquid outlet is in an axially symmetric shape.

3. The device for controlling the shape of discharged liquid according to claim 1, wherein the liquid outlet channel is rotationally twisted with a center axis of the liquid outlet channel as a rotation center, and cross-sections of different positions of the rotationally twisted liquid outlet channel in the liquid outlet direction are in a rotationally symmetric shape corresponding to the shape of the liquid outlet.

4. The device for controlling the shape of discharged liquid according to claim 1, wherein an area of the liquid outlet is smaller than areas of the cross-sections of the liquid outlet channel, a guide section is disposed on an inner wall of the liquid outlet channel and is communicated with the liquid outlet, and an area of a cross-section of the guide section is constant or decreases gradually in the liquid outlet direction.

5. The device for controlling the shape of discharged liquid according to claim 1, wherein a slow-down section is disposed in the passage or the liquid outlet channel, an area of a cross-section of the slow-down section decreases gradually in the liquid outlet direction, and a change rate of the area of the cross-section of the slow-down section decreases gradually in the liquid outlet direction.

6. The device for controlling the shape of discharged liquid according to claim 5, wherein at least one said slow-down section is disposed in the liquid outlet channel.

7. The device for controlling the shape of discharged liquid according to claim 5, wherein at least one said slow-down section is disposed in the passage.

8. The device for controlling the shape of discharged liquid according to claim 1, wherein cross-sections of different positions of the passage in the liquid outlet direction are in a same shape and are of a rotationally symmetric structure, and areas of the cross-sections in the passage are equal.

9. The device for controlling the shape of discharged liquid according to claim 1, wherein guide ribs are disposed in the passage and are perpendicular to the liquid outlet direction.

10. The device for controlling the shape of discharged liquid according to claim 1, wherein a filter device used for reducing a pressure of liquid and slowing down the liquid is disposed at an end, close to the liquid outlet channel, in the passage.

11. The device for controlling the shape of discharged liquid according to claim 1, wherein at least one said liquid outlet is formed, at least one said liquid outlet channel is disposed, and the at least one liquid outlet channel is in one-to-one correspondence with the at least one liquid outlet.

12. The device for controlling the shape of discharged liquid according to claim 1, wherein a temperature control device is disposed at an end, close to the liquid inlet end, in the passage.
